(19) United States
(12) Patent Application Publication
(10) Pub. No.: US 2009/0230315 A1
(43) Pub. Date: Sep. 17, 2009

(54) Neutron Imaging Camera, Process and Apparatus for Detection of Special Materials

(75) Inventors: Stanley D. Hunter, Laurel, MD (US); Noel A. Guardala, Columbia, MD (US)

Correspondence Address: NASA GODDARD SPACE FLIGHT CENTER, 8800 GREENBELT ROAD, MAIL CODE 140.1, GREENBELT, MD, 20771, US

(73) Assignee: United States of America as represented by the Administrator of the National Aeronautics and Spac, Washington, DC (US)

(21) Appl. No.: 12/048,972

(22) Filed: Mar. 14, 2008

(51) Int. Cl. G01T 3/00

(52) U.S. Cl. 250/390.01

(57) ABSTRACT

Systems, processes, and apparatus are described through which fast neutrons are detected, their momenta are measured and a position of a source of the fast neutrons is determined from the measured momenta. For example, a multiple-cell neutron-sensitive camera is described. Each cell includes a neutron detection cell that also functions as a time expansion chamber and a micro-well detector coupled to the time expansion chamber.

### ORIGIN OF THE INVENTION

The invention described herein was made by one or more employees of the United States Government and may be manufactured and used by or for the Government of the United States of America for governmental purposes without the payment of any royalties thereon or therefor.

### FIELD OF THE DISCLOSURE

This disclosure relates generally to measurement apparatus for detection of special nuclear materials, in particular, to a neutron imaging camera, and more particularly, to techniques and apparatus capable, for example, of functioning as an inspecting and/or monitoring device in many applications on land, sea, and air platforms, both manned and unmanned to determine presence and/or location of special nuclear materials using both passive and active interrogation methods.

### BACKGROUND

The increasingly large volume of international trade is typically effectuated by shipping goods in containers, also known as ISO containers or isotainers. “ISO” refers to The International Organization for Standardization, an international standard-setting body composed of representatives from various national standards bodies which produces world-wide industrial and commercial standards.

Such containers are constructed so that they may be manipulated via cranes or other heavy equipment, and thus loaded and sealed intact onto and/or readily transferred between container ships, railroad cars, planes, and trucks, for example, to effectuate intermodal transport capability. In the context of ship-borne cargo, containers are stored in container storage yards prior to and after transfer from ship to shore and vice versa, and are typically stacked about four containers high within the storage yard.

The sheer number of containers transported by a single container ship or box ship, or one train or other vehicle, from one port or country to another, together with the rather large internal volume of each container, render comprehensive inspection of incoming goods shipped in this manner impractical and ineffectual. Among other things, the delay involved in opening each individual container, removing the contents, inspecting the materials by hand, replacing the contents etc. represent excessive costs. This also would result in delay crippling to international trade, and inspection via this means additionally and necessarily results in damage to some fraction of the items being shipped. Over one million containers enter the United States daily, via a combination of sea, air and land transportation.

Alternative methods for attempting to detect illegal importation of fissile materials, that is, materials which could be employed in forming a “dirty bomb” or other nuclear explosive device, rely on scanning procedures that introduce onerous delays in trans-shipment of materials, incur unreasonably high costs in practice, and do not pinpoint location of potentially devastatingly deadly materials with sufficient accuracy.

At the same time, increasing concern regarding illegal importation of even relatively small amounts of special nuclear materials, including weapons-grade fissile materials, such as Plutonium-239 (²³⁹Pu), has resulted in desire to promote more thorough inspection of goods being imported into a country, with a goal of interception and interdiction, prior to reaching or passing through US ports. However, it is not practical, for many reasons, including inability to effectively search for some types of nuclear materials contraband via hand inspection, to attempt comprehensive hand inspection of the contents of each container.

Nuclear materials may be tracked via indicia such as detection of a number of different particle types, including alpha particles, beta particles (energetic electrons, e⁻), neutrons, and gamma rays emitted from these types of matter. However, of these indicia, alpha particles, beta particles (energetic electrons, e⁻), and gamma rays are also readily masked via suitable shielding.

These various problems and developments indicate increasing need for new tools and/or processes facilitating rapid location and identification of any particular container or other repository containing special nuclear materials, such as weapons-grade plutonium, without requiring excessive labor, and without inducing delay in trans-shipment of goods. For the reasons stated above, and for other reasons discussed below, which will become apparent to those skilled in the art upon reading and understanding the present disclosure, there are needs in the art to provide improved detectors in support of increasingly stringent and exacting performance and measurement standards in settings such as “hands-off” or “stand-off” inspection of relatively large volumes of goods or materials via passive or active interrogation.

### SUMMARY

The above-mentioned shortcomings, disadvantages, and problems are addressed herein, which will be understood by reading and studying the following disclosure.

In one aspect, the present disclosure contemplates a multiple-cell neutron-sensitive camera. Each cell of the camera includes a combination of a time expansion chamber and a micro-well detector array coupled to the time expansion chamber.

In another aspect, a neutron momentum measurement apparatus includes a plurality of neutron defection cells. Each neutron detection cell of the plurality includes a time expansion chamber and a micro-well detector array coupled to the time expansion chamber. Individual micro-wells in the array are arranged in an addressable mosaic and provide electrical connections to at least two conductors. The conductors form at least two buses. The neutron momentum measurement apparatus also includes front end electronics coupled to at least one of the at least two buses. The front end electronics includes an array of charge amplifiers, shaping amplifiers, and analog-to-digital conversion circuitry coupled to at least one of the at least two buses.

In a further aspect, the present disclosure describes a process for determination of a location of a source of fast neutrons. The process includes detecting presence of ionizing radiation in a first cell of a neutron detection apparatus when a first threshold condition is exceeded. The process also includes determining, responsive to detecting, when a fast neutron has been detected, via presence of characteristic signature associated with a second threshold condition. The process further includes calculating momentum of the detected fast neutron when determining indicates that a fast neutron has been detected. The process additionally includes combining the calculated momentum with other calculated momentum data from at least a second cell of the neutron detection apparatus to derive a location of the source relative to the neutron detection apparatus.

Systems, apparatus, and processes of varying scope are described herein. In addition to the aspects and advantages described in this summary, further aspects and advantages will become apparent by reference to the drawing, and by reading the detailed description that follows.

### BRIEF DESCRIPTION OF THE DRAWINGS

FIG. 1 is a simplified block diagram of an overview of a shipping container storage area, illustrating one of many applications of the subject matter of the present disclosure.

FIG. 2 is a simplified block diagram of an array of the detector portions of a neutron imaging camera useful in the context of FIG. 1.

FIG. 3 is a simplified block diagram illustrating a plan view of a micro-well detector and associated components useful in the context of the neutron imaging camera of FIG. 2.

FIG. 4 is a simplified composite of a side view taken along section lines IV(i)-IV(i) of FIG. 2 in combination with a side view taken along section lines IV(ii)-IV(ii) of FIG. 3, illustrating operating principles of a time expansion ionization chamber and a micro-well.

FIG. 5 depicts experimental gas gain versus voltage for three different micro-well depths.

FIG. 6 is a simplified exemplary representation of elastic neutron scattering in a hydrocarbon medium.

FIG. 7 is a simplified exemplary representation of boron-ten (¹⁰B) neutron capture.

FIG. 8 is a simplified representation of an n-p interaction on He-three (³He).

FIG. 9 graphically depicts triton particle range, and

FIG. 10 illustrates proton range, for two different conditions applicable to the n-p reaction of FIG. 8.

FIG. 11 is a graph descriptive of representative sensitivity for the n-p reaction depicted in FIG. 8.

FIGS. 12 and 13 compare Examples 1 and 2 (FIG. 12) and Examples 2 and 3 (FIG. 13).

FIG. 14 is a flowchart providing a blueprint of a process for characterization of momentum for a fast neutron using the apparatus disclosed herein.

FIG. 15 compares neutron spectra for shielded vs. unshielded weapons-grade plutonium.

FIG. 16 shows, for a one cubic meter device, simulated neutron imaging camera integral neutron detection rate from one kilogram of weapons-grade plutonium, scaled by the integration time divided by the square of the distance.

FIG. 17 is a simplified diagram illustrating a deployment scenario for a neutron imaging camera or cell, in accordance with an embodiment of the subject matter of the disclosure.

FIG. 18 is a simplified diagram illustrating a deployment scenario for a neutron imaging camera or cell, in accordance with an embodiment of the subject matter of the disclosure.

### DETAILED DESCRIPTION

In the following detailed description, reference is made to the accompanying drawings that form a part hereof, and in which are shown, by way of illustration, specific embodiments which may be practiced. These embodiments are described in sufficient detail to enable those skilled in the art to practice the embodiments, and it is to be understood that other embodiments may be utilized, and that logical, mechanical, electrical, and other changes may be made, without departing from the scope of the embodiments. As used herein, the term “drift” as applied to ions and charged particles implies motion of the individual ions or charged particles, responsive to an applied electrical field (in contradistinction to motion of particles via other physical processes, such as diffusion, etc.).

Ranges of parameter values described herein are understood to include all subranges falling therewithin. The following detailed description is, therefore, not to be taken in a limiting sense,

As used herein, the term “neutron imaging camera” is defined to describe a device capable of triangulation of a source of neutrons via multiple “cells” of such a neutron imaging camera. Each cell, in turn, is defined to include a single active gas volume bounded by a micro-well detector array on one side, a drift electrode on an opposed side, and a field shaping grid surrounding a volume between the one and the opposed side.

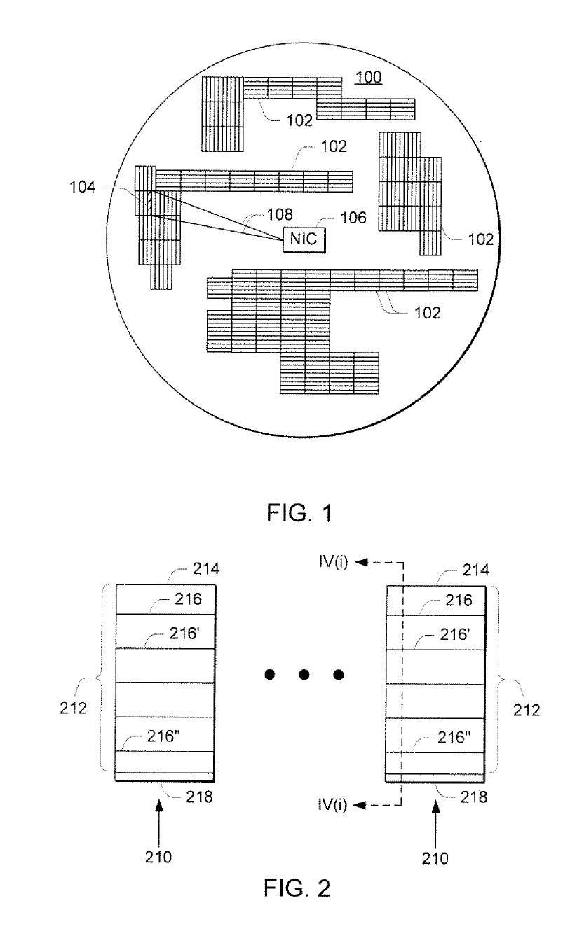

The detailed description is divided into eight sections, in the first section (FIG. 1 and associated text), a system level overview is provided. In the second section (FIGS. 2 through 5 and associated text), a physical example of a neutron detection system capable of identifying small quantities of special nuclear materials (including highly enriched uranium, weapons-grade plutonium, etc.), and their location, is presented, in the third section (FIGS. 6 through 11 and associated text), several examples of neutron interactions are described.

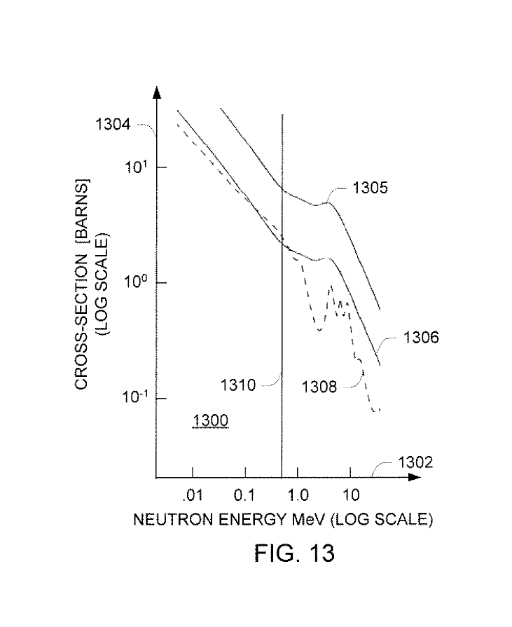

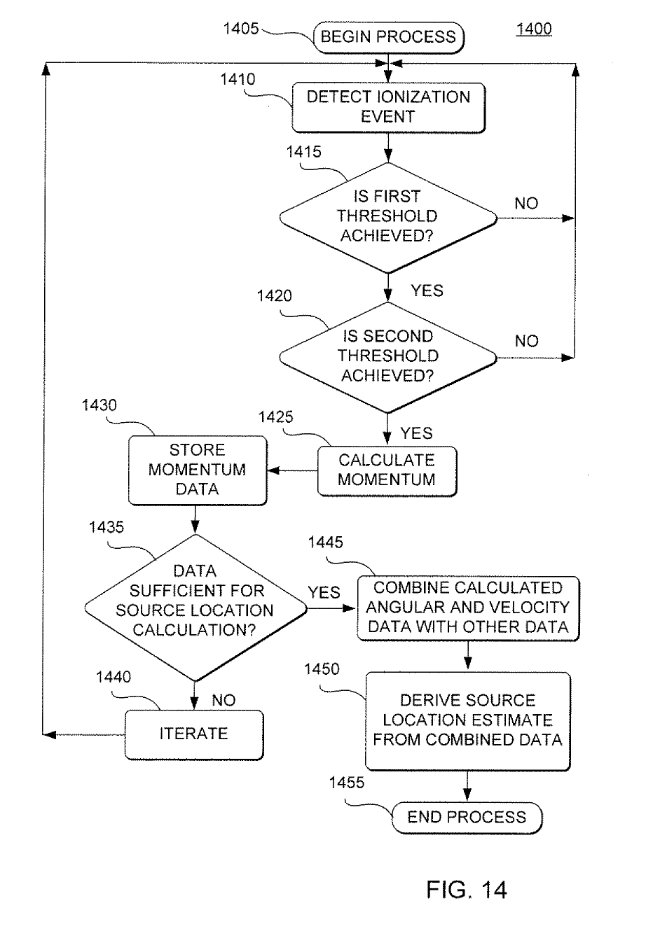

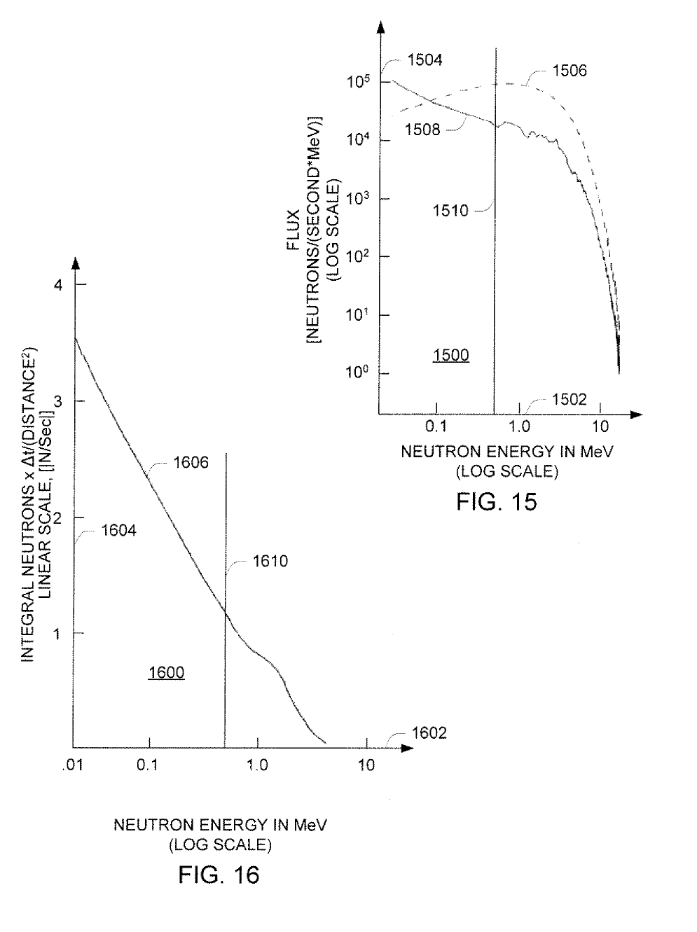

In the fourth section (FIGS. 12 and 13 and associated text), general characteristics applicable to the examples of the preceding sections are described, in the fifth section (FIG. 14 and associated text), a process for characterization of ionization events is described. In the sixth section (FIGS. 15 and 16 and associated text), general characteristics of the principles of the disclosed detection apparatus are described. In the seventh section, a variety of alternative sensing and deployment scenarios are presented, in the eighth section, a conclusion of the detailed description is provided. A technical effect of the systems and processes disclosed herein includes at least one of facilitating capability for measurement of direction of fast neutrons emitted from special nuclear materials and rapid determination of location of even relatively small amounts of such special nuclear materials.

### §I. System Overview

FIG. 1 is a simplified block diagram of an overview of a shipping container storage area 100, illustrating one of many applications of the subject matter of the present disclosure. The container storage area 100 includes a large number of shipping containers 102, typically stacked four high. In the example of FIG. 1, only one container 104 (shaded) contains weapons-grade plutonium. A neutron imaging camera 106, which includes a processor (not illustrated in FIG. 1 for simplicity of illustration and ease of understanding) and is able to employ multiple neutron detection events in order to define a range 108 of angles within which the container 104 is located. When the neutron imaging camera 106 comprises multiple cells 210, both angle and distance may be found using well-known principles of back projection and triangulation.

Neutrons having energies Eₙ of less than 200 keV (200 kilo electron volts) have severely limited angular and energy information vis-a-vis the source from which they originated, due to scattering events. “Fast neutrons” (those having energies of greater than ˜0.2 MeV, or mega electron volt, and particularly, those having energies above one-half MeV) are difficult to shield, and display minimal scattering in atmosphere. As a result, directional information is retained for fast neutrons within a radius consistent with inspection (for example, on the

When multiple cells 210 or neutron imaging cameras 106 are utilized, the range can be defined via stereoscopic principles. As a result, the neutron imaging camera 108 is capable of uniquely, non-invasive and rapidly identifying the particular container 104 containing the weapons-grade plutonium or other special nuclear materials by detection of neutrons having an energy above 0.2 MeV or in a range extending at least from 200 keV MeV to several MeV or more.

Detection of neutrons, rather than other fission products, by the presently-disclosed neutron imaging camera 108 presents advantages in that neutrons are not as readily shielded as many other types of radiation emergent from such radioactive decay, i.e., beta particles, gamma rays and alpha particles. Fast neutrons are also not as readily scattered by the atmosphere and other materials as are other types of radiation. As a result, determination of the three-dimensional direction and energy of reaction products allows determination of the angle of the source from which the neutrons originated relative to the neutron imaging camera 106. Determination of the angles from multiple cells in the neutron imaging camera 106 allows determination of the location of the source via stereoscopic comparison of data from at least two cells or via triangulation from a neutron camera 106 that includes two or more cells. As a result, a stand-off or remote sensing capability for rapidly determining presence of special nuclear materials is realized. The neutron imaging camera 106 is described in more detail in §II, infra.

### §II. Simple Example Of A Neutron Imaging Camera

FIG. 2 is a simplified block diagram of neutron detection apparatus or neutron imaging camera portions 206 including an array of neutron detector portions or neutron detection cells 210 useful in the context of the neutron imaging camera 106 of FIG. 1. The neutron detector portions or neutron detection cells 210 in the group of such cells 210 forming the neutron imaging camera 206 each include a time projection tower or time expansion ionization chamber 212 having a drift electrode 214 at one end. In one embodiment, an array of field shaping electrodes or wires 216, 216′, . . . , 216″ extend around a body of each of the time expansion chambers 212. In one embodiment, a single array of field shaping electrodes or wires 216, 216′, . . . , 216″ surround the ensemble of time expansion chambers 212.

A detector array 218 is located at an end of each time expansion chamber 212 distal from the respective drift electrode 214. Typical dimensions for the cells 210 are on the order of 50 cm by 50 cm (corresponding to the area of the drift electrode 214 and thus to the area of the detector array 218). As a result, in this example, four cells occupy a area of about one square meter, however, larger or smaller cells may be employed, and may be chosen specifically for the task at hand.

The detector array 218 is biased positively with respect to the associated drift electrode 214. As a result, and as is described in more detail below with respect to FIG. 4, electrons e⁻ arising from ionizing events in each of the time expansion chambers 212 drift from a respective point of origin towards the detector array 218 associated with that time expansion chamber 212.

It has been found that the time required for an electron e⁻ to drift (vertically downward) to the detector array 218 is reduced by some three orders of magnitude, with relatively little diffusion (lateral motion), via introduction of an electronegative gas in appropriate proportions. As an example, an electron e⁻ combines with a carbon disulfide gas molecule CS₂ to form a drift ion, CS₂⁻. Alternatively, any of many other gases might in principle be usefully employed. These may include methane and other hydrocarbons, other electronegative gases, such as sulfur hexafluoride (SF₆), nitro-methane (CH₃NO₂), carbon tetrachloride (CCl₄), and other known gases.

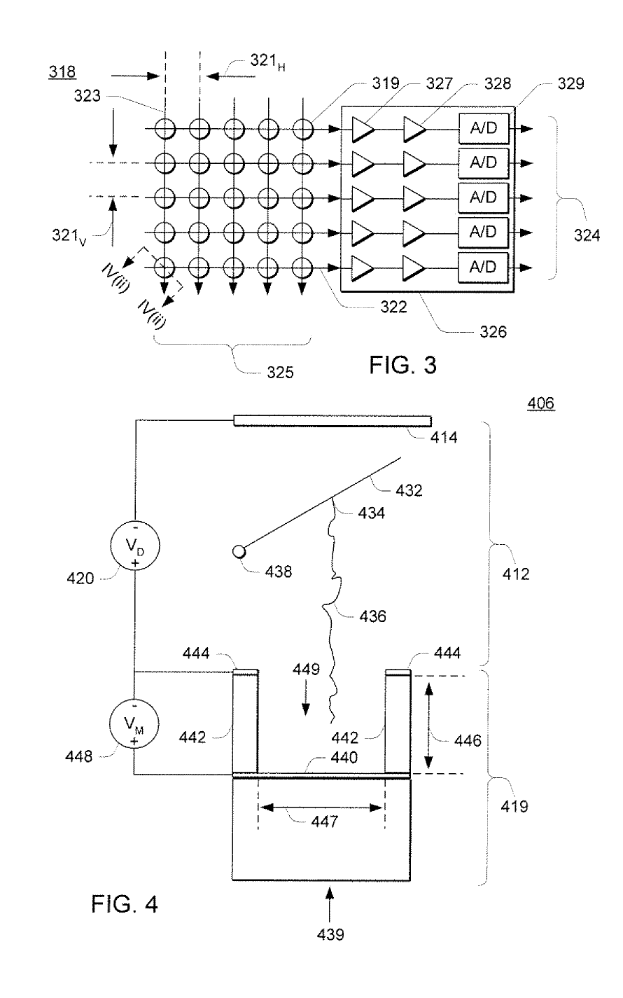

FIG. 3 is a simplified block diagram illustrating a plan view of a micro-well detector array 318 and associated components useful in the context of the neutron imaging camera 200 of FIG. 2. The view of FIG. 3 corresponds to looking downward towards the detector array 218 in the representation of FIG. 2.

The micro-well detector array 318 includes a mosaic of micro-wells 319 having a vertical pitch 321_{V} and a horizontal pitch 321_{H}. Individual micro-wells 319 within the array 318 are Illustrated as being arranged in rows 322 and columns 323. Output buses 324 and 325 are illustrated as forming a Cartesian array, allowing signals from each micro-well 319 to be independently identified, processed and characterized. Front end electronics 328 are only shown as being associated with the rows 322 for ease of illustration and simplicity of description. It will be appreciated that similar or other signal processing and conditioning circuitry is associated with the columns 323.

Typical values for the vertical pitch 321_{V} and the horizontal pitch 321_{H} are on the order of four hundred micrometers, although larger or smaller pitches 321 may foe employed. Also, while the example shown in FIG. 3 represents the vertical pitch 321_{V} and the horizontal pitch 321_{H} as being approximately equal, for simplicity of illustration and ease of understanding, it will be understood that the vertical pitch 321_{V} and the horizontal pitch 321_{H} need not be equal. It will also be appreciated that while the individual micro-wells 319 are shown as being arranged in an array 318 in conformance with a right-angled Cartesian coordinate system, any coordinate system may be employed in arranging the micro-wells 319, provided that the addressing scheme associated with the buses 324 and 325 is appropriately adjusted.

The front end electronics include charge amplifiers 327 individually coupled to each row 322 and having outputs coupled to pulse-shaping amplifiers 328, The pulse-shaping amplifiers 328 have outputs coupled to respective inputs of analog-to-digital converters A/D 329, which include sample-and-hold circuits as an integral portion thereof. Digital signals representations of the analog signals on the row lines 322 thus are output on the bus 325.

The charge amplifiers 327 associated with the examples disclosed herein typically have noise characteristics of ˜1,000 e⁻ RMS and sensitivities of ˜2 milliVolts per femto-Coulomb. In part due to the time expansion properties of the time expansion ionization chamber 212 of FIG. 2, the front-end electronics 326 may have combined characteristics supporting, for example, one to two and a half mega samples per second with, for example, twelve bits of resolution and a buffer capability of 20,000 samples per channel.

In practice, some 10,000 front end electronic channels may be needed. An ASIC (application specific integrated circuit) may be an attractive way to realize these functions.

FIG. 4 is a simplified composite of a side view taken along section lines IV(i)-IV(i) of FIG. 2, in combination with a side view taken along section lines IV(ii)-IV(ii) of FIG. 3, of a portion 406 of the neutron imaging camera 206 of FIG. 2 and cells 306 and 406 of FIGS. 3 and 4. FIG. 4 illustrates operating principles of a time expansion ionization chamber 412 (corresponding to section lines IV(i)-IV(i) through the time expansions chamber 212 of FIG. 2) and a micro-well 419 (corresponding to section lines IV(ii)-IV(ii) through a micro-well 319 in FIG. 3). FIG. 4 is not drawn to scale.

The active tracking volume in the time expansion chamber 212 (FIG. 2) or 412 (FIG. 4) is bounded by a drift electrode 214 or 414 at one end, and a detector array 218 or micro-well detector array 318 (FIG. 3) or a micro-well 419 (FIG. 4) forming a portion of a detector array such as 318 at an opposed end. The drift electrode 414 is negatively biased to a drift voltage V_{D} by a power supply 420 with respect to the micro-well 419. The drift voltage is set relative to the cathode voltage to provide an electric field of about one thousand Volts/centimeter in the drift volume. Ionization electrons e⁻ are formed along the trajectory of ionizing particles, and those electrons combine with electronegative gas molecules to provide negative ions 436 to drift towards the micro-well detector element 419. The ionized gas molecules 436 drift toward the anode (formed by the micro-well 419) of the time expansion chamber 412. The electrons are stripped from the negative ion in the much higher electrical fields within the micro-well detector array 318 and micro-wells 319, 419 and an avalanche of secondary gas ionization results in the strong electric field (circa 40 kiloVolts/centimeter) set up by a high voltage V_{M} applied between the anodes and cathodes of the micro-wells 319, 419. The avalanche charge is collected on the anode electrode 440 and an equal but opposite image charge is collected on the cathode electrode 444. Signals from the anode electrode 440 and the cathode electrode 444 are produced essentially simultaneously, thereby allowing the x, y position of the micro-well 419 with the avalanche to be determined from a time correlation of the charge pulses in the transient digitizer outputs.

Negative ions 436 resulting from ionization of the electronegative gas molecules drift much more slowly than an electron e⁻ would. This results in substantial effective time expansion with

respect to the arrival of these ions 436 at the detector array 218 or micro-well detector array 318 or the micro-well 419. Consequently, speed requirements for the electronic detection apparatus (e.g., front end electronics 329 of FIG. 3) are greatly reduced and yet allow them to be able to determine relative times of arrival of the tons in a series of micro-wells 319 within the micro-well array 318 or a series of micro-wells 419 along a two-dimensional projection of the path of the ionizing particle.

A dielectric substrate 439 supports the micro-well 419. A bottom conductor forms an anode 440 of the micro-well 419. A dielectric material 442 separates the anode 440 from a cathode 444.

The micro-well 419 has a depth 446 that is typically on the order of seventy-five to several hundred micrometers, and a width 447 that may be one hundred to several hundred micrometers. The width 447 may be defined as a fraction of the pitch 321, with values of about one-half providing useful results, although larger or smaller ratios may be employed.

A power supply 448 provides a multiplication voltage V_{M}. As a result, a high field gain region 449 is realized deep in the micro-well 419, and can give rise to a gain of at least 30,000 via avalanche multiplication of the primary electron e⁻ 438 without suffering instability.

One benefit to this geometry is that ultraviolet radiation from the avalanche process giving rise to the gas gain of the micro-well 419 is shielded. The electronegative gas, if poly-atomic as is CS2, is strongly absorbing of UV photons. As a result, most of that radiation is absorbed within each micro-well 419, avoiding breakdown from photon feedback and thus obviating need for a quench gas,

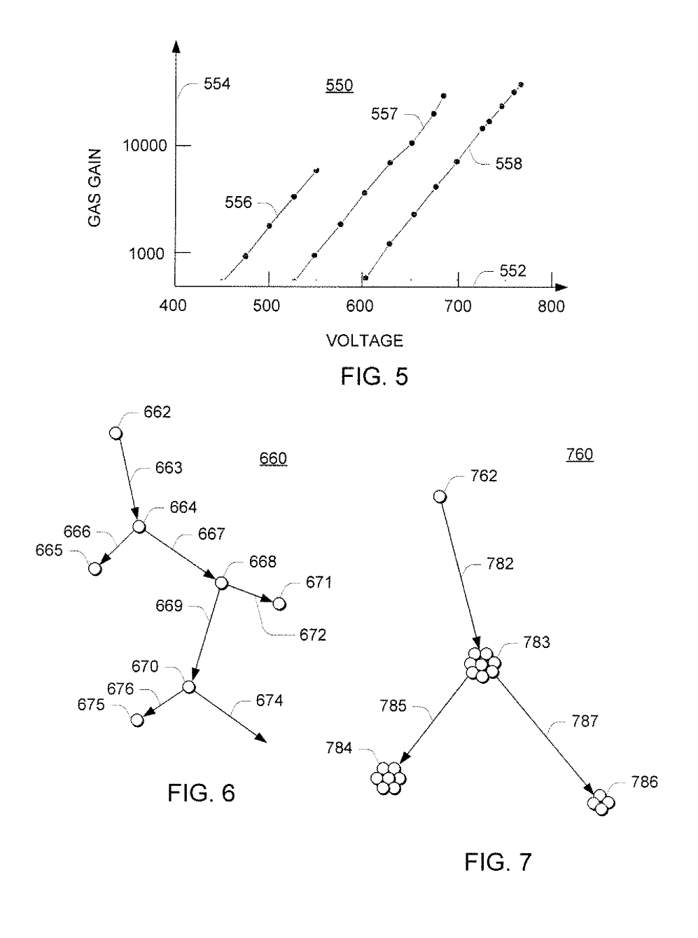

The dielectric material 442 is typically about 400 micrometers thick, i.e. has a thickness similar to the diameter of the micro-well 419. When the cathode 444 is 800 volts more negative than the anode 440, a field of about 20,000 volts per centimeter is realized within the micro-well 419. The micro-well detector 419 is a type of proportional counter detector and gas gain can be realized with a wide range of gases and mixtures. For example, use of argon is able to provide gas gains of in excess of 10,000, under such conditions (see FIG. 5 and associated text, infra). Use of noble gases, also known as the helium family or the neon family, i.e., one or more of helium (He), neon (Ne), argon (Ar), krypton (Kr), or xenon (Xe), for example, as a proportional gas or ionization gas, within the micro-well 419, provides significant gas gains. Gas gain can be realized with tend to provide relatively favorable ionization energies vis-a-vis at least some other gases, however, other gases may be usefully employed.

Micro-wells 419 having a pitch of circa four hundred micrometers and a diameter of about two hundred micrometers provide sufficient spatial resolution to track a two-dimensional plot of the trajectory of the ionizing particles 432. Measurement of differences in time of arrival provides the third dimension, allowing the trajectories of the ionizing particles 432 to be determined in three dimensions. In turn, the three-dimensional trajectory of the incoming fast neutron may be inferred from the trajectories of the ionizing particles 432.

Within the time expansion chamber 412, an ionizing particle 432 causes an ionization event 434, resulting in an electron e⁻ which then forms a negative ion 438 and a spalation ion or particle 438. For example, when an incoming particle (not illustrated in FIG. 4) is a fast neutron, and that fast neutron is captured by ¹⁰B in the form of ¹⁰BF₃, the resultant ionizing particles are ⁷Li and an alpha particle, with energies of >0.95 MeV and >1.7 MeV, respectively, and respective ranges of circa 2 to 3 and 4 to 8 millimeters, when the time expansion chamber 412 contains one atmosphere of enriched (90%) ¹⁰BF₃. In turn, these reaction products 432 each give rise to a series of ionization events 434 as they travel, and the resulting pattern of electrons e⁻ and thus of negative ions 438 resulting from electrons released by those ionization events 434 track the trajectories of the ionizing particles 432 and thus allow reconstruction of the trajectory of the incoming fast neutron. Similar analysis using known parameters applies to use of other gases, such as the ³He(n, p)T reaction, described below with reference to §III(C).

FIG. 5 depicts experimental gas gain (up to the limit of stability) versus voltage for three different depths of micro-well 419 using P-10 (90% argon, 10% methane) at a pressure of slightly less than one atmosphere. The graph 550 in FIG. 5 has an abscissa 552 calibrated in voltage difference across and an ordinate 554 calibrated in gas gain (e.g., in electrons per electron) on a logarithmic scale. A first curve 556 corresponds to depth 446 of 3 mils or about 75 micrometers, a second curve 557 corresponds to a depth 446 of five mils of about 125 micrometers and a third curve 558 corresponds to a depth 446 of eight mils or about 200 micrometers. The curves demonstrate gas gains in excess of 10,000 for depths 446 of five mils (125 micrometers) or more, at voltages of more than 600 volts.

A variety of different nuclear processes may be employed in the neutron imaging camera 106 of FIG. 1. In §III of the present disclosure, infra, several examples illustrative of the principles of operation of such neutron imaging cameras 106 and 206 are described.

### §III. EXAMPLES

Different types of neutron interactions may be harnessed to determine directional data from fast neutrons. These include inelastic scattering, one form of which is described below in §III(A), in Example 1, with respect to a hydrocarbon scattering medium. Another type interaction is discussed in §III(B) and involves capture of a neutron by the nucleus of an atom which is then rendered unstable and undergoes radioactive decay. Example 2 describes this type of event with boron 10 (¹⁰B) as the target. Yet another type of reaction, represented in §III(C), involves conversion of ³He to triton (heavy hydrogen). Example 3 describes this type of event. Other types of known nuclear interactions, e.g., recoil from helium four, may also be employed in conjunction with the teachings of the present disclosure.

### §III(A). Example 1

FIG. 6 is a simplified representation 660 of inelastic neutron scattering in a hydrogen-rich (e.g., methane, CH₄; or a mix of methane with ethylene, aka ethene, C₂H₄) medium. An incoming neutron 662 traveling along a first trajectory 663 is incident on a scattering site 664, such as a hydrogen atom which is part of a gaseous molecule. As a result, a recoil proton 665 is ejected from the molecule 664 and travels along a trajectory 666. Protons, in general, are highly ionizing particles. This event, and the trajectory 666, are marked by a trail of ionizing events, such as 434 of FIG. 4.

The neutron 662 is scattered, and, consequently the neutron trajectory 663 is modified to a new trajectory 667. The neutron 662 continues to travel, albeit with less energy as a result of the scattering, and then undergoes a second collision at a second scattering site 668. A second proton 671 is ejected along a trajectory 672, and gives rise to further ionizing events. The neutron 662 continues to travel along a new trajectory 669, striking a third molecule 870.

A third proton 675 is ejected along a trajectory 676, which also is measurable via the ionization trail created by the third proton 675. The neutron 662 continues along a third trajectory 674.

In Example 1, only the recoil protons 865, 671, 675 are ionizing particles. As a result, the trajectories 663, 667, 670 do not give rise to ionization frails. Consequently, multiple collisions are required in order to determine the angle and energy of the incoming neutron 662. Three (as depicted in FIG. 6) or more (not shown) interactions, when property sequenced, provide an estimate of the incoming neutron 682 energy and scatter angle. This approach does not provide true imaging, rather a collection of overlapping circles, one for each neutron 662 detected. The density of the overlapping circles provides a measure of the probability of the direction of the detected neutrons 662. Multiple neutron sources, or moving sources, add substantial confusion to this approach.

### §III(B). Example 2

FIG. 7 is a simplified representation 760 of boron-ten (¹⁰B) neutron capture. In Example 2, the time expansion chambers 212, 412 (FIGS. 2 and 4, respectively) include a boron-ten containing gas such as boron triflouride (¹⁰BF₃). Typically, the pressure of this gas is on the order of one atmosphere, however, other pressures may be employed.

An incoming neutron 762 traveling on a trajectory 782 strikes a ¹⁰B nucleus 783. The ¹⁰B nucleus 783 then is transformed to excited ¹¹B which then promptly disintegrates to ⁷Li and an a particle. Both the α particle and the lithium ion produce are ionizing particles and produce ionization trails.

In Example 2, fast neutrons 762 captured on ¹⁰B give rise to ⁷Li and a breakup ions having respective energies of >0.95 MeV and >1.07 MeV, corresponding to respective ranges of about two millimeters and six millimeters under the conditions described herein. Thus, the RMS angular uncertainty of the ⁷Li and a breakup ions is ˜4.5° and ˜1.9°, respectively. The resulting angular uncertainty for the neutron 762 is estimated from the quadrature sum to be <5°.

The reaction described above (boron neutron capture) creates a characteristic “V”-shaped pair of trajectories. In general, nuclear reactions resulting in relatively low mass of the reaction products or breakup fragments provide relatively longer resultant trajectories, and thus facilitate accuracy in directional assessments. Consequently, analysis of the data from the micro-well detectors 419 allows discrimination between neutron reaction products and other forms of incident radiation.

### §III(C). Example 3

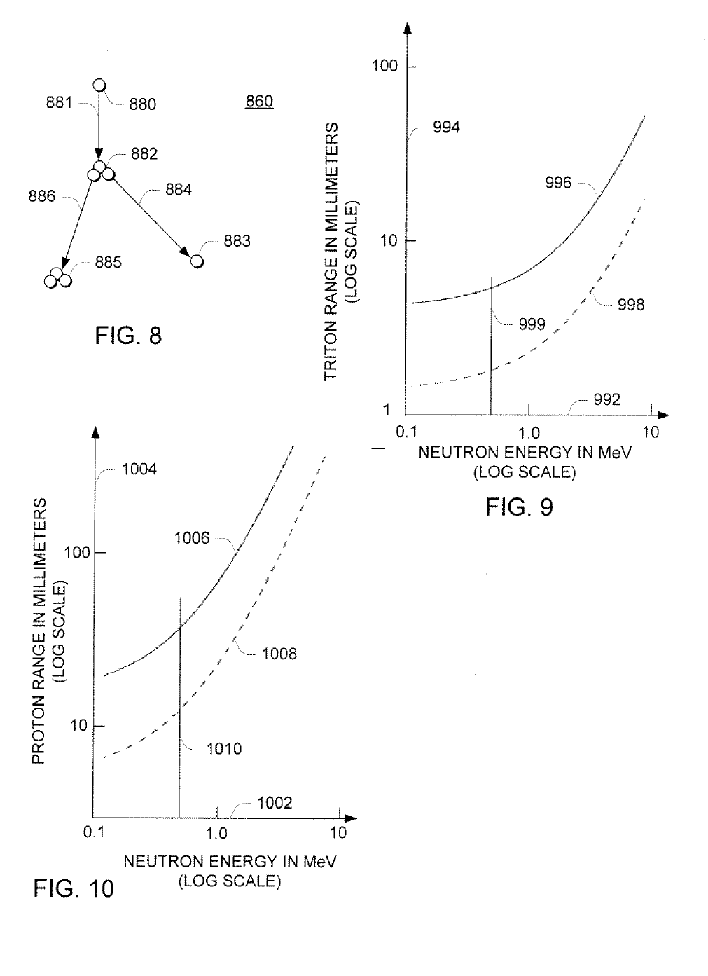

FIG. 8 is a simplified representation 860 of an n-p interaction on helium-three (³He). In Example 3, the time expansion chambers 212, 412 (FIGS. 2 and 4, respectively) include ³He and CS₂ gasses. Typically, the pressure of this gas mixture is on the order of one to several atmospheres, however, other pressures may be employed.

An incoming fast neutron 880 traveling on a trajectory 881 strikes an atom of ³He 882. This, in turn, causes a proton 883 to be ejected and to travel on a trajectory 884. The ³He 882 is converted to triton 885 (an atom of ³He) traveling along a trajectory 886.

FIG. 9 illustrates a graph 900 depicting range for triton 885, The graph 900 has an abscissa 992 and an ordinate 994. The abscissa 992 represents neutron energy on a log scale, while the ordinate 994 represents triton 885 range, also on a log scale. A curve 996 (solid trace) corresponds to triton 885 range at a pressure of one atmosphere, while a curve 998 (dashed trace) corresponds to triton 885 range at a pressure of three atmospheres. Vertical bar 999 denotes a neutron energy of one-half MeV.

FIG. 10 shows a graph 1000 illustrating proton range for the conditions described with reference to FIG. 9. The graph 1000 has an abscissa 1002 and an ordinate 1004. The abscissa 1002 represents neutron energy on a log scale, while the ordinate 1004 represents proton 884 range, also on a log scale. A curve 1006 (solid trace) corresponds to proton 884 range at a pressure of one atmosphere, while curve 1008 (dashed trace) corresponds to proton 884 range at a pressure of three atmospheres. Vertical bar 1010 denotes a neutron energy of one-half MeV.

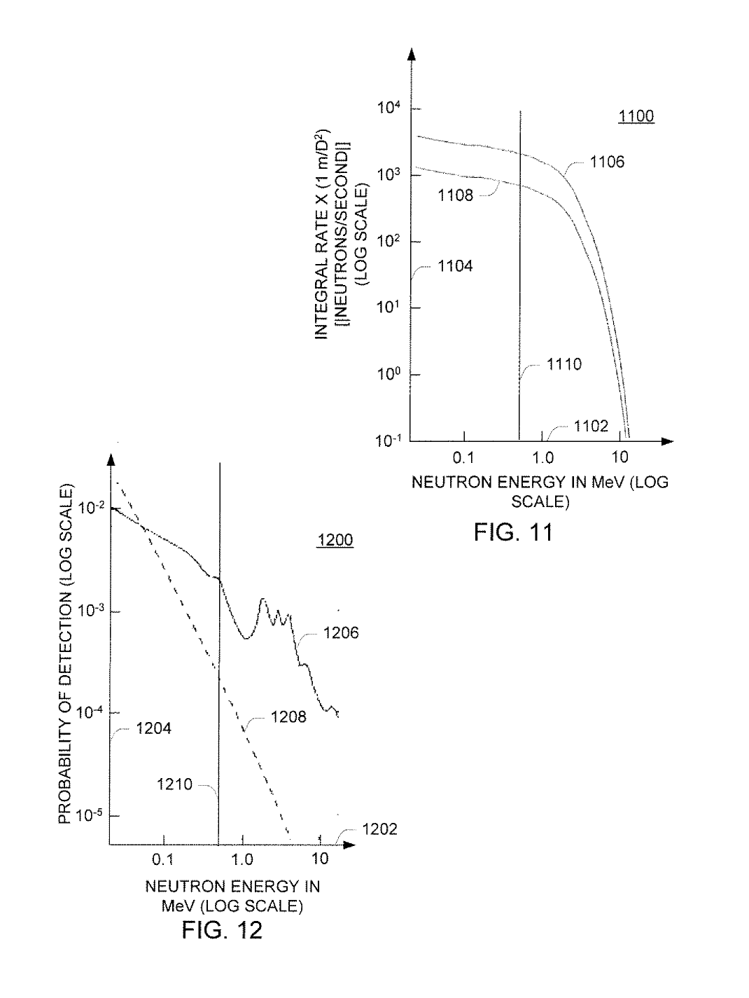

FIG. 11 is a graph 1100 descriptive of representative sensitivity for the n-p reaction depicted in FIG. 8. The graph 1100 has an abscissa 1102 and an ordinate 1104. The abscissa 1102 abscissa 1102 represents neutron energy on a log scale, while the ordinate 1104 represents scaled sensitivity, also on a log scale. A curve 1106 (upper trace) corresponds to a pressure of three atmospheres, while a curve 1108 (lower trace) corresponds to a pressure of one atmosphere. Vertical line 1110 corresponds to a neutron energy of one-half MeV.

Three examples of nuclear interactions, relevant at least to fast neutrons, and giving rise to ionizing breakup ions, have been provided. These are discussed in comparative terms below in §IV.

### §IV. Comparison of Examples 1, 2 and 3.

Some comparisons of salient characteristics of §§III(A), (B) and (C) (i.e., Examples 1, 2, and 3, supra) are provided below, in general, the n-p reaction on helium-three (³He) of §III(C) requires ³He, which presently is much more costly than other detection gases, but which is also capable of providing relatively high sensitivity. The boron-ten (¹⁰B) neutron capture reaction of §III(B) (Example 2) provides less sensitivity than the n-p reaction on helium-three (³He) of §III(C) (Example 3), but more sensitivity than the proton scattering process of §III(A) (Example 1).

Table I below summarizes examples of gases usable in various roles in neutron detection apparatus, such as are described herein. Table I includes a list of examples of gases which find utility in one or more of a variety of roles.

TABLE I
Exemplary lists of gases having utility in the context of the present
disclosure, including examples of gases having multiple utility.

| | | | e⁻ negative | |
|---|---|---|---|---|
| | | Neutron | diffusion | |
| GAS | Ionization | detection | suppression | UV quench |
| ³He | Yes | Yes | Possible | No |
| ⁴He | Yes | Yes | Possible | No |
| ⁶Li | Possible | Yes | Possible | Possible |
| ¹⁰BF₃ | Yes | Yes | Possible | Possible |
| Ne | Yes | Unknown | Possible | No |
| Ar | Yes | Unknown | Possible | No |
| Kr* | Yes | Unknown | Possible | No |
| Xe | Yes | Unknown | Possible | No |
| CH₄ | Yes | Yes‡ | Unknown | Yes |
| C₂H₄ | Yes | Yes‡ | Unknown | Yes |
| C₂H₆ | Yes | Yes‡ | Unknown | Yes |
| C₂H₅OH† | Yes | Yes‡ | Unknown | Yes |
| C₃H₆ | Yes | Yes‡ | Unknown | Yes |
| C₄H₈ | Yes | Yes‡ | Unknown | Yes |
| CO₂ | Yes | Unknown | Possible | Yes |
| CS₂† | Yes | Unknown | Yes | Yes |
| CCl₄† | Yes | Unknown | Yes | Yes |
| CH₃NO₂† | Yes | Possible | Yes | Yes |
| SF₆ | Yes | Unknown | Yes | Yes |

*non-radioactive forms only
†liquids at STP; maintained in gaseous form by keeping partial pressure below vapor pressure
‡via inelastic scattering; generally applicable to hydrocarbons

FIG. 12 depicts a graph 1200 illustrating relative cross-sections for triple neutron proton scattering (Example 1, §III(A)) and the boron neutron capture reaction (Example 2, §III(B)). The graph 1200 includes an abscissa 1202 and an ordinate 1204. The abscissa 1202 corresponds to neutron energy expressed on a logarithmic scale. The ordinate 1204 corresponds to probability of detection, also expressed on a logarithmic scale.

A curve 1208 (solid trace) represents cross-section for the boron neutron capture reaction (Example 2, §III(B)) using 90% enriched ¹⁰BF³, at one atmosphere, while a relative cross-section for triple neutron proton scattering is represented by a curve 1208 (dashed trace) in CH₄ at three atmospheres (Example 1, §III(A)). Vertical bar 1210 denotes a neutron energy of one-half MeV. Comparison of the curves 1206 and 1208 shows that the ¹⁰BF₃ reaction provides at least one order of magnitude greater sensitivity.

FIG. 13 provides a graph 1300 representing a comparison of sensitivities for the triton reaction (Example 3, §III(C)) and the boron triflouride reaction (Example 2, §III(B)). The graph 1300 has an abscissa 1302 and an ordinate 1304. The abscissa 1302 represents neutron energy on a logarithmic scale. The ordinate 1304 corresponds to probability of detection, also expressed on a logarithmic scale.

A curve 1306 corresponds to the triton reaction at a pressure of three atmospheres. A curve 1306 represents the triton reaction at a pressure of one atmosphere. A curve 1308 (analogous to the curve 1206 of FIG. 12) illustrates probability for neutron capture on ¹⁰B. Vertical bar 1310 denotes a neutron energy of one-half MeV. Comparison of the curves 1305 and 1306 to the curve 1308 shows that the ³He(n, p)T reaction provides overall higher interaction probability than the ¹⁰B reaction for neutrons with energies greater than about 1 MeV at a pressure of 1 atmosphere and at all neutron energies at a pressure of 3 atm.

Increasing the pressure of the ¹⁰BF₃ gas increases the probability for neutron capture, but the angular resolution, derived from the measured of the ⁷Li and α tracks, is decreased, because the track lengths are decreased. Increasing the ³He pressure likewise decreases the ³H and p track lengths. In this case, however, the angular resolution is improved because the ³H and p tracks are more fully contained within the drift volume, providing a more accurate measurement of their energies.

The examples of §III(A) through §III(C) involve common acts when implemented as described above, using the apparatus exemplified by the discussion in §III. The acts collectively form a process and are summarized below in §III with reference to FIG. 14 and associated text.

### §V. Process

FIG. 14 is a flowchart 1400 providing a blueprint of a process for characterization of momentum for a fast neutron, and thus for determining location of a source of the fast neutrons, using the apparatus disclosed herein. The process 1400 begins with an act 1405,

In an act 1410, the process 1400 responds to one or more signals indicative of ionization events from at least one cell 210. In other words, the act 1410 detects an ionization event that has occurred by assessing two degrees of freedom of motion of ionization electrons via two-dimensional data from a micro-well detector coupled to a first cell in a time expansion chamber 212, via signals corresponding to that ionization event manifested on signal lines 325, 328. When an ionization event has been detected via the acts of block 1410, control passes to a query task 1415.

In the query task 1415, the process 1400 determines when the ionization event detected in the block 1410 provides indicia in excess of a first programmable threshold level. The one or more signals may arise from one or more of the signal lines 322, 323 of FIG. 3, and be manifested via appropriate elements of either or both of buses 324, 325. Setting a programmable number representing a suitable duration composed of sequential time slots in conformance with clocking/timing signals provided to the front end electronics 326 comprises specification of a portion of the criteria for determination that the first programmable event criteria have been observed. The block 1410 and the query task 1415 thus collectively detect presence of ionizing radiation in a first cell 210 of a neutron detection apparatus 106 when a first threshold condition is exceeded.

When the query task 1415 determines that the ionization event detected via the block 1410 does not achieve the first threshold, control returns to the block 1410. In other words, the process 1400 resets to wait for another ionization event to be detected.

When the query task 1415 determines that the first threshold has been achieved, control passes to a query task 1420. The query task 1420 determines when a second threshold has been achieved. In one embodiment, the query task 1420 includes determining, from data regarding the ionization electrons, at least two paths each corresponding to a respective ionized entity via relative timing data from multiple wells of the micro-well detector array 318, When the query task 1420 determines that the second threshold has not been achieved, control returns to the block 1410, as described above. When the query task 1420 determines that the second threshold has been achieved, control passes to a block 1425.

In the block 1425, momentum of the incoming neutron is estimated by first characterizing the momenta of the tons which have been detected. A first portion of the momenta information may come from the query task 1420, e.g., from assessing two degrees of freedom of motion of ionization electrons via two-dimensional data from a micro-well detector coupled to a first cell. The third component of motion is calculated by determining time differences between collisions (thus allowing the energy loss neutron velocity to be determined) and timing differences between data from the series of micro-wells along the two-dimensional projection of the ton path (allowing the three-dimensional motion of the ion to be calculated).

In one embodiment, the second threshold corresponds to detection of characteristics of a fast neutron being scattered in a hydrocarbon medium. In one embodiment, the second threshold corresponds to detection of characteristics of a fast neutron colliding with helium three, i.e., conversion of ³He to triton (heavy hydrogen, ³H). When either the query task 1415 indicates that the first threshold was not achieved, or the query task 1420 indicates that the second threshold was not achieved, the data from the most recent iteration of the block 1410 are discarded.

In the block 1425, a momentum of a particle giving rise to the ionization event detected in the block 1410 and confirmed via the query tasks 1415, 1420 is calculated. The way in which this is done depends on the detection mechanism being employed. Trajectories and intervals between detection events are employed to calculate the momentum of the fast neutron. Control then passes to a block 1430.

In the block 1430, the momentum data calculated in the block 1425 are stored in a memory. Control then passes to a query task 1435.

In the query task 1435, the stored data from multiple detected ionization events are analyzed to determine when the cumulative amount of data is sufficient to provide an accurate estimate of a position of a source of the radiation being detected. When the query task 1435 determines that insufficient data exists for forming an accurate estimate of the location of a source of the radiation, control passes to a block 1440, and the process 1400 iterates.

When the query task 1435 determines that the stored data permit an accurate estimate of the position of a source to be identified, control passes to a block 1445. In the block 1445, calculated angular and velocity data (momentum data) are combined with stored data from other fast neutron detection events. Control then passes to a block 1450.

The types of information assessed in the query task 1435 in determining when the stored data are sufficient to estimate a source include the number of “hits” associated with each cell 210 of the neutron imaging camera 106 and the number of cells 210 which provide data that could be associated with a single source 104. When the data indicate that multiple sources 104 are likely, the stored data elements are grouped according to the apparent direction of the source 104, and are analyzed in the block 1445 within the context of the resulting separate groups.

In the block 1450, a source 104 location is estimated from the combined data from the block 1445. The process 1400 then ends in a block 1455, and can iterate to refine the source 104 location estimate or trigger an annunciator to indicate presence of a source 104 comprising special nuclear materials.

The process 1400 incorporates characteristics common to the examples shown above with reference to §III. The characteristics common to the neutron imaging camera 106 (FIG. 1) and described in more detail in §II of this disclosure are summarized below in §VI with reference to FIGS. 15 and 16.

### §VI. Characteristics Relevant to Neutron Imaging Cameras

In this section, characteristics common to the examples of neutron imaging disclosed in §III are described. Neutron imaging is based on measuring neutron momenta, the direction and velocity or energy of the neutrons. The direction and energy of the incoming neutrons may be measured by the ionization tracks and energy deposited by recoil protons (§III(A), Example 1) or breakup particles (§III(B) and (C), Examples 2 and 3, respectively).

A variety of particles are emitted by special nuclear materials, including α, β particles, and γ rays. These types of particles are readily absorbed by shielding materials. Slow neutrons (Eₙ<one keV) can, in principle, provide large count rates, however, the angular and energy data they provide is severely limited. Fast neutrons (Eₙ>0.5 MeV) provide substantially fewer counts, are difficult to shield and exhibit minimal scattering along their path. Therefore, they present a long mean free path, several hundred meters, thereby preserving directional and energy information. These characteristics are employed by the neutron imaging camera 106, 206 of FIGS. 1 and 2 to detect fast neutrons via processes such as are described above in §III with reference to Examples 1, 2, and 3, using the detection apparatus described in §II with reference to FIGS. 2 through 5.

A first level triggering signal is generated by comparing the signals from each of the channels (e.g., on the bus 326 of FIG. 3) to a programmable threshold value. When the signal on any one channel of the bus 324 is above the threshold value for several (e.g., ˜three to five) contiguous samples, the first level triggering signal is generated.

The second-level trigger signal results in analysis of timing information from the micro-well detectors. This timing information, in turn, allows an estimation of the particles relative emission angles. That data can be used to construct an estimate of angular information which defines the incoming neutron. By a suitable comparison of signals from multiple detection cells, the location of one or more special nuclear material targets may be identified with substantial accuracy.

FIG. 15 is a graph 1500 illustrating relative neutron flux versus neutron energy for shielded and unshielded targets. The graph 1500 has an abscissa 1502 and an ordinate 1504. The abscissa 1502 corresponds to the neutron energy expressed on a logarithmic scale. The ordinate 1504 represents neutron flux, also represented on a logarithmic scale. A curve 1506 (dashed trace) corresponds to neutron flux from a target comprising one kilogram of weapons-grade plutonium (e.g., six percent ²⁴⁰Pu). A curve 1508 (solid line) describes neutron flux from the same target, but shielded by a ten centimeter thick shell of water surrounding a 5 centimeter thick special shell of iron surrounding the target. Vertical bar 1510 denotes a neutron energy of 0.5 MeV.

FIG. 16 shows a graph 1600 of the simulated integral neutron detection rate, generated by the neutron imaging camera produced by one kilogram of weapons-grade plutonium scaled by the integration time divided by the square of the distance. The graph 1600 has an abscissa 1602 and an ordinate 1604. The abscissa 1602 corresponds to the neutron energy expressed on a logarithmic scale. The ordinate 1604 represents the integral of the number of neutrons multiplied by the measurement time interval (Δt), all divided by the distance squared, on a linear scale, with dimensions of neutrons per second.

A curve 1606 corresponds to simulating the expected detection rate from one kilogram of weapons-grade plutonium scaled by the integration time divided by the square of the distance in meters. Vertical bar 1610 denotes a neutron energy of 0.5 MeV.

### §VII. Alternative Examples and General Discussion

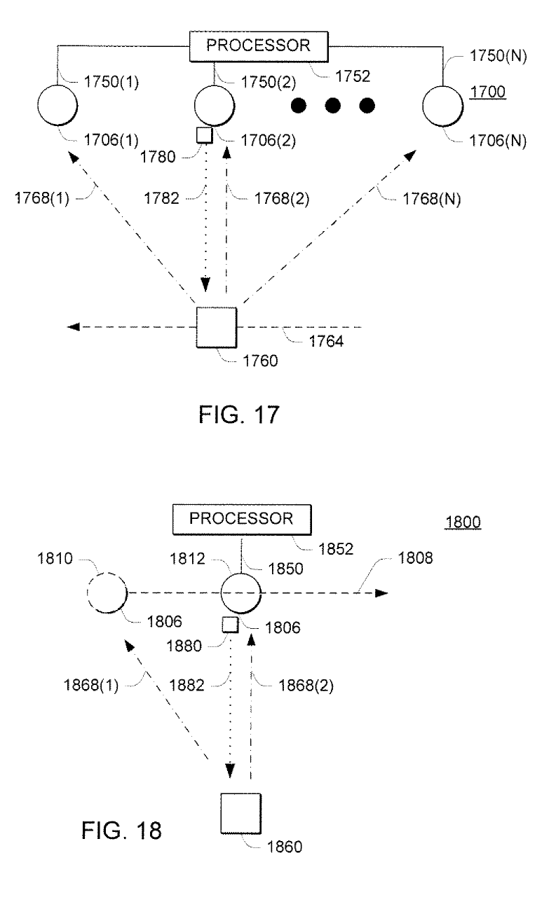

In the preceding six sections, a number of operational principles were described, and some discussion of known phenomena as applied to new situations was presented, in this section, a variety of different implementation considerations are presented with reference to FIGS. 17 and 18.

The example described above in §I, with reference to inspection of incoming shipping containers in the context of a seaport, fails to address a number of current problems. For example, should a critical amount of special nuclear materials arrive and be off-loaded in a seaport, irreparable damage may well have already been done. Detonation of a nuclear device or dispersal of special nuclear materials in a major shipping area in the receiving country may present significant disruption of shipping, as well as major loss of life, and/or significant nuclear contamination. Consequently, what is needed is what is called “very forward deployment” of detection technologies.

In other words, what is needed is to detect special nuclear materials well outside of the local area. For example, it would be highly desirable to ensure that special nuclear materials are not included in shipments to a designated port by inspection of the contents (not merely the manifest) of a shipping vehicle, which may be an airborne, seaborne or land transportation vehicle, at and/or en route to the port of departure. Additional inspection, well away from the port of destination, may also be desirable, because release or dispersal of some types of special nuclear materials at a port can present disastrous consequences as well as irreparable harm.

A fixed location for the nuclear imaging camera 106 of FIG. 1 or one or more of the cells 210 of FIG. 2 may fail to provide the desired information relative to a moving vehicle containing a suspicious or undesirable payload, such as special nuclear materials. Some highly dangerous materials, such as highly enriched uranium or even moderately enriched uranium, may not be detectable based solely on passive neutron signature alone. Such materials, however, may provide recognizable neutron signatures when fission is induced via active interrogation, for example by irradiation with a suitable flux of particles, for example, by an appropriate flux of neutrons or gamma rays.

FIG. 17 is a simplified diagram illustrating a deployment scenario including a dispersed detection station or apparatus 1700 including a plurality of N-many neutron defectors 1706(N), in accordance with an embodiment of the subject matter of the disclosure. The neutron detector array 1706, in this example, includes one or multiple neutron detectors 1706(1), 1706(2) . . . 1706(N), each having a respective data communications path 1750(1), 1750(2) . . . 1750(N) to one or more processors 1752. The neutron detectors 1706 may be relatively stationary, and may each comprise one or more neutron detection cells, such as the neutron detection cells 210 of FIG. 2, which may be organized in various ways.

The data communications paths 1750 may be unidirectional, that is, only supplying information from the neutron detectors 1706 to the processor 1752, or may be bidirectional, that is, also capable of conveying instructions or other information from the processor to specific ones of the neutron defectors 1750. In general, data from each neutron detector 1706 includes timing information as well as the type of path data provided by ionization events within each of the neutron defectors 1706.

An object 1760 to be inspected is moving along a predetermined path 1764, as indicated by the dashed line and arrow. It should be recognized that while only one row of neutron detectors 1706 are illustrated along one side of a path 1764 for simplicity of illustration and ease of understanding, both sides of the path 1764 may include linear or other forms of arrays of neutron defectors 1706. It should also be noted that the neutron detectors 1706 need not be deployed in linear arrays and need not all be in any one plane; the neutron detectors 1706 may be at different altitudes (or depths) and may be arranged in any fashion suited to the type of inspection being performed.

Neutrons may be emitted from the object, and neutrons traveling along any of the paths 1768(1), 1768(2) . . . 1768(N) may be detected by the respective neutron detector 1706(1), 1706(2) . . . 1788(W) intersected by the corresponding path. Back projection coupled with timing data is communicated to the processor 1752 and allows the processor 1752 to use data from the discrete neutron detectors 1706 to determine which particular object 1760 (for example, a railroad car which is part of a train moving along the path 1764, or a portion of a ship passing over or through a detection station 1700) includes special nuclear materials within it.

Some types of special nuclear materials are of concern, but provide relatively sparse amounts of neutrons in comparison to ²⁴⁰Pu. This is true, even though the physical amounts of these other special nuclear materials needed to cause a nuclear event are larger than the amount of ²⁴⁰Pu that could be employed for such purposes. For example, under ordinary conditions, highly enriched uranium (HEU) or even modestly enriched uranium (that is, uranium which has been processed to segregate ²³⁵U from the dominant natural isotope, ²³⁸U) emits neutrons at a rate that is orders of magnitude lower than the rate at which weapons-grade plutonium or ²⁴⁰Pu emit neutrons.

Consequently, providing one or more optional sources 1780, each capable of producing an appropriate flux 1782 of particles, such as neutrons or gamma rays, can enhance the rate of neutron emission from some types of special nuclear materials, such as enriched uranium, which may be contained within the object 1760, to levels consistent with practical detection, that is, to produce sufficient neutrons per unit time while irradiated via the optional source (or sources) 1780 to make detection practical. When only one neutron detector 1706 is employed, and the special nuclear materials contained in the object 1760 are moving, it may not be possible to determine the location of the special nuclear materials. Use of multiple, but physically separated, neutron detectors 1706(1), 1706(2), . . . 1706(N) at known locations can allow accurate determination of the presence of fissile materials and can be used to detect even fissile materials having long half-lives. In other words, irradiation of special nuclear materials that produce relatively few neutrons per unit time under ordinary conditions, may enhance a neutron emission rate to promote efficient and timely detection capabilities.

This can be accomplished, for example, when one or more excitation or particle sources 1780 are combined with, or dispersed near or along the path 1764, or are configured to be able to operate in conjunction or cooperation with the neutron detectors 1706, to provide a flux of particles along a path 1782 (indicated by a dotted line and arrow), such as a flux of neutrons or gamma rays.

It will be appreciated that other types of conventional monitoring equipment (e.g., infrared and/or visible light cameras, etc.) may be co-integrated into the apparatus 1700, or with any of the other embodiments described above with reference to FIGS. 1 through 16. As a result, a suite of different types of sensors (e.g., visible and/or infrared cameras together with neutron detectors 1706) may be combined in order to achieve detection capability for a wide range of different types of materials, some of which may not be neutron sources, via a single detection station 1700.

The neutron detectors 1706 may comprise individual detectors 1706, or discrete, separated neutron detection cells (each analogous to one of the cells 210 of FIG. 2) or may comprise individual (multi-cell) neutron imaging cameras (analogous to the camera 106 described above with reference to FIG. 1, et seq.). The links 1752 at least allow data to go from the individual respective detectors 1706 to the processor 1752, or may be bi-directional links allowing commands to go from the processor 1752 back to the detectors 1706, and the links 1750 may include hard-wired links, which may be encrypted and which may include RF, microwave, acoustic, or optical links.

The embodiment depicted in FIG. 17 includes at least some neutron detectors 1706 having relatively fixed positions vis-a-vis a path of travel 1764 for goods 1760. The path of travel 1764 may constitute a road, a railway, a shipping lane, a flight path, a path taken by goods being transferred by crane, etc. Relative positions of the neutron detectors 1706 and the path of travel 1765 are known, for example, via conventional GPS receivers, and the processor 1752 may include present relative positional data for the neutron detectors 1706 and the path of travel 1764, even when one or more of the neutron detectors 1706 may be in motion.

FIG. 18 is a simplified diagram illustrating a deployment scenario for a neutron detector 1800, in accordance with an embodiment of the subject matter of the disclosure. A neutron detector 1806 is depicted as traveling along a path 1808, from a path including at least a first position 1810 to at least a second position 1812. An object 1860 is illustrated at a relatively fixed position, and the object 1860 may contain special nuclear materials.

Neutrons traveling along the path 1868(1) from the object 1860 at a first time, when the neutron detector 1806 is intersected by the path 1868(1), will be detected by the neutron detector 1806 at the position 1810. Similarly, neutrons traveling along the path 1868(2) will be detected by the neutron detector 1806 when the neutron detector 1806 is intersected by the path 1868(2), i.e., at a later point in time, when the neutron detector is at the position 1812.

In contrast to the scenario shown in FIG. 17, where the object 1760 is moving and the neutron detector or detectors 1706 are relatively stationary, a single neutron detector 1806 which is moving can be used to determine the position of special nuclear materials which may be contained in the object 1860, or multiple such neutron detectors 1806 may be employed, using well-known principles of triangulation to determine a unique locus associated with such special nuclear materials. As noted above, a suite of detectors of varying types may be incorporated or associated with the neutron detector 1806 to enable defection of a broad variety of signatures indicative of different types of materials of interest. Also, as noted above with reference to FIG. 17, one or more particle sources, such as the particle source 1880, providing a stimulus comprising suitable flux 1882 as noted above, may be included in the deployment scenario 1800.

### §VIII. CONCLUSION

Apparatus, systems, and processes implementing a novel imaging camera based on neutron detection are described. The disclosed neutron imaging arrangements provide capability for stand-off detection of special nuclear materials via passive and/or active interrogation and find application in a wide range of terrestrial, airborne and/or marine scenarios.

Earth-based situations where the disclosed neutron imaging technology finds utility include facility/installation protection, border crossing monitoring (aerial or ground based), portal and high seas monitoring via active or passive detection techniques. The camera and the techniques employed by the camera are unusually rugged, respond to radiation that is difficult to obscure, provide high sensitivity, and achieve large field-of-view and accurate point-source imaging and location identification capabilities in modest form factor.

Although specific embodiments have been illustrated and described herein, it will be appreciated by those of ordinary skill in the art that any arrangement which is calculated to achieve the same purpose may be substituted for the specific embodiments shown. This disclosure is intended to cover any adaptations or variations. For example, although described in procedural terms, one of ordinary skill in the art will appreciate that implementations can be made in a procedural design environment or any other design environment that provides the required relationships.

In particular, one of skill in the art will readily appreciate that the names or labels of the processes and apparatus are not intended to limit embodiments. Furthermore, additional processes and apparatus can be added to the components, functions can be rearranged among the components, and new components to correspond to future enhancements and physical devices used in embodiments can be introduced without departing from the scope of embodiments.

One of skill in the art will readily recognize that embodiments are applicable to future elements capable of the functionality described herein. The terminology used in this disclosure is meant to include all alternate technologies which provide the same functionality as described herein.

What is claimed is:

1. A multiple-cell neutron-sensitive camera, each cell of the camera including in combination:
a time expansion chamber; and
a micro-well detector array coupled to the time expansion chamber.

2. The neutron-sensitive camera of claim 1, wherein the time-expansion chamber includes:
a drift electrode at a first end of the cell; and
one or more field-shaping electrodes distributed between the first end and a second end, wherein the micro-well detector is positioned at the second end.

3. The neutron-sensitive camera of claim 1, wherein the micro-well detector comprises:
a baseplate formed of dielectric material and having a surface;
a first array of electrodes formed on the surface, the first array comprising first conductive strips having a first pitch and extending in a first direction;
a dielectric layer having a lower surface bonded to the surface overlying the first conductive strips, the dielectric having a Cartesian array of openings formed therethrough, each of the openings exposing a portion of only one of the first conductive strips; and
a second array of electrodes formed on an upper surface of the dielectric layer and comprising second conductive strips each having a series of apertures therethrough, each aperture surrounding a respective one of the openings, the second conductive strips having a second pitch and arranged relative to the first conductive strips and the openings in conformance with the Cartesian array, wherein each of the openings presents a maximum lateral dimension of roughly one-half of a smaller of the first and second pitches.

4. The neutron-sensitive camera of claim 1, wherein the time expansion chamber comprises a closed volume containing a gas selected from a group consisting of: a hydrocarbon gas, methane (CH₄), ethene (C₂H₄), ethane (C₂H₆), ethanol (C₂H₅OH), propane (C₃H₆), butane (C₄H₈) helium-three (³He), helium-four (⁴He), boron-ten triflouride (¹⁰BF₃), argon (Ar), xenon (Xe), and a lithium-six (⁶Li) gas.

5. The neutron-sensitive camera of claim 1, wherein the neutron imaging camera includes multiple cells which are physically separated.

6. The neutron-sensitive camera of claim 1, wherein the micro-well array includes an ionization gas.

7. The neutron-sensitive camera of claim 1, wherein the time expansion chamber and the micro-well array include:
a neutron detection gas;
an electronegative gas; and
an ionization gas.

8. A neutron momentum measurement apparatus comprising:
a plurality of neutron detection cells, each neutron detection cell of the plurality including:
a time expansion chamber; and
a micro-well detector array coupled to the time expansion chamber,
individual micro-wells in the array being arranged in a addressable mosaic and providing electrical connections to at least two conductors, the conductors forming at least two buses; and
front end electronics coupled to at least one of the at least two buses, the front end electronics including an array of charge amplifiers, shaping amplifiers and analog-to-digital conversion circuitry coupled to at least one of the at least two buses.

9. The neutron momentum measurement apparatus of claim 8, wherein each time expansion chamber comprises:
an enclosed volume containing a gas at a pressure of about three atmospheres; and
a drift electrode associated with one end of the enclosed volume,
wherein the micro-well coupled to the time expansion chamber is at an end distal from the one end.

10. The neutron momentum measurement apparatus of claim 8, wherein each time expansion chamber contains a mixture of:
an electronegative gas; and
a detection gas chosen from a group consisting of: a hydrocarbon gas, methane (CH₄), ethene (C₂H₄), ethane (C₂H₆), ethanol (C₂H₅OH), propane (C₃H₆), butane (C₄H₈), helium-three (³He), helium-four (⁴He), and boron-ten triflouride (¹⁰BF₃), argon (Ar), xenon (Xe), and a lithium-six (⁶Li) gas.

11. The neutron momentum measurement apparatus of claim 8, wherein the plurality of neutron detection cells are physically separated from each other and are collectively coupled to a processor.

12. The neutron momentum measurement apparatus of claim 8, wherein each time expansion chamber and associated micro-well array includes a gas chosen from a group consisting of: a hydrocarbon gas, methane (CH₄), ethene (C₂H₄), ethane (C₂H₆), ethanol (C₂H₅OH), propane (C₃H₆), butane (C₄H₈), helium-three (³He), helium-four (⁴He), and boron-ten triflouride (¹⁰BF₃), argon (Ar), and xenon (Xe).

13. The neutron momentum measurement apparatus of claim 8, wherein each micro-well array includes:
a gas chosen from a group consisting of argon and xenon; and
wherein each detection cell includes:
a mixture of carbon disulfide gas and
a gas chosen from a group consisting of: boron-ten
triflouride (¹⁰BF₃), a hydrocarbon, helium-three (³He), or helium-four (⁴He).

14. The neutron momentum measurement apparatus of claim 8, wherein each micro-well array comprises micro-wells organized in an orthogonal Cartesian mosaic with equal horizontal and vertical pitch.

15. A process for determination of a location of a source of fast neutrons, the process including:
detecting presence of ionizing radiation in a first cell of a neutron detection apparatus, when a first threshold condition is exceeded;
determining, responsive to detecting, when a fast neutron has been detected, via presence of characteristic signature associated with a second threshold condition;
calculating momentum of the detected fast neutron when determining indicates that a fast neutron has been detected; and
combining the calculated momentum with other calculated momentum data from at least a second cell of the neutron detection apparatus to derive a location of the source relative to the neutron detection apparatus.

16. The process of claim 15, wherein detecting and determining includes:
assessing two degrees of freedom of motion of ionization electrons via two-dimensional data from a micro-well detector;
calculating, from data regarding the ionization electrons, path data for at least two paths each corresponding to a respective ionized entity via relative timing data from multiple wells of the micro-well detector; and
comparing the path data to data representing the characteristic signature.

17. The process of claim 15, wherein detecting and determining further includes:
detecting when exceeding the first threshold indicates an event other than detection of a fast neutron, or, when determining indicates the first threshold has been exceeded,
determining when the second threshold condition has not been exceeded, via absence of the characteristic signature; and
discarding data when either the first or the second threshold has not been exceeded.

18. The process of claim 15, wherein at least the first and second cells include a gas having first atomic entities capable of capturing a fast neutron to provide an excited atomic entity, and, wherein, responsive to capturing, the excited atomic entity provides at least one ionizing breakup ion, and further comprising:
detecting ionization electrons when any excited atomic entity captures a fast neutron, that molecule provides at least one strongly ionizing breakup ion;

19. The process of claim 15, wherein the first and second cells each include a mixture of carbon disulfide gas and a gas chosen from a group consisting of: boron-ten triflouride (¹⁰BF₃), a hydrocarbon, helium-three (³He), helium-four (⁴He), and a noble gas.

20. The process of claim 15, wherein the first and second cells each include a mixture of an electronegative gas, a noble gas, and a gas chosen from a group consisting of: a mixture of carbon disulfide gas, and a gas chosen from a group consisting of: boron-ten triflouride (¹⁰BF₃), a hydrocarbon, helium-three (³He), or helium-four (⁴He).
